(19) United States
(12) Patent Application Publication
(10) Pub. No.: US 2019/0359211 A1
(43) Pub. Date: Nov. 28, 2019

(54) TRAVEL ASSISTANCE DEVICE, TRAVEL ASSISTANCE METHOD, AND COMPUTER PROGRAM

(71) Applicants: AutoNetworks Technologies, Ltd., Yokkaichi (JP); Sumitomo Wiring Systems, Ltd., Yokkaichi (JP); Sumitomo Electric Industries, Ltd., Osaka-Shi (JP)

(72) Inventors: Tadashi Matsumoto, Yokkaichi (JP); Takeshi Hagihara, Yokkaichi (JP); Yuichi Kodama, Yokkaichi (JP); Yasuhiro Yabuuchi, Yokkaichi (JP)

(21) Appl. No.: 16/412,649

(22) Filed: May 15, 2019

(30) Foreign Application Priority Data
May 24, 2018 (JP) 2018-099908

(51) Int. Cl. B60W 30/14; G08G 1/0967; B60W 50/14

(52) U.S. Cl. CPC B60W 30/143; B60W 2050/146; B60W 50/14; G08G 1/096783

(57) ABSTRACT

A travel assistance device mounted in a vehicle includes an in-vehicle communication unit to which position information regarding the vehicle, intersection information, and traffic signal information are input. A vehicle speed deriving unit derives a recommended speed of the vehicle and is connected to the in-vehicle communication unit. The vehicle speed deriving unit derives the recommended speed of the vehicle based on intersection information and traffic signal information regarding a first intersection that are input from the in-vehicle communication unit, and on the position information regarding the vehicle, updates the recommended speed, if intersection information and traffic signal information regarding a second intersection are input before the vehicle passes through the first intersection, based on the intersection information and the traffic signal information regarding the second intersection, and on the position information regarding the vehicle, and outputs the derived or updated recommended speed via the in-vehicle communication unit.

### CROSS-REFERENCE TO RELATED APPLICATIONS

This application claims priority of Japanese Patent Application No. JP 2018-099908 filed May 24, 2018, the contents of which are incorporated herein.

### TECHNICAL FIELD

The present disclosure relates to a travel assistance device, a travel assistance method, and a computer program.

### BACKGROUND

In recent years, travel assistance systems have been put into practical use to assist the traveling of vehicles by transmitting, to the vehicles, information regarding intersections and information regarding traffic signals installed at intersections from road-side communicators that are installed near intersections.

JP 2010-170322A is an example of related art.

In the case of using infrared communication using near-infrared light as wireless communication between a road-side communicator and an in-vehicle communication device mounted in a vehicle, infrared communication has characteristics of strong directivity and a narrow communication area compared with wireless communication using radio waves in a specific frequency band (e.g. 5.9 GHz band). For this reason, in the travel assistance using infrared communication, it is common to generate travel assistance information based on information from a road-side communicator that is closest to the vehicle, and travel assistance cannot be performed while also giving consideration to information from a traffic signal that is installed farther away.

The present disclosure has been made in view of the foregoing situation, and aims to provide a travel assistance device, a travel assistance method, and a computer program that enables travel assistance to be performed while giving consideration to a traffic signal that is installed farther away.

### SUMMARY

A travel assistance device according to an aspect of the present application is a travel assistance device to be mounted in a vehicle, the device including: an in-vehicle communication unit to which position information regarding the vehicle, intersection information, and traffic signal information are input; and a vehicle speed deriving unit configured to derive a recommended speed of the vehicle, the vehicle speed deriving unit being communicably connected to the in-vehicle communication unit, wherein the vehicle speed deriving unit derives the recommended speed of the vehicle based on intersection information and traffic signal information regarding a first intersection that are input from the in-vehicle communication unit, and on the position information regarding the vehicle, updates the recommended speed, if intersection information and traffic signal information regarding a second intersection are input before the vehicle passes through the first intersection, based on the intersection information and the traffic signal information regarding the second intersection, and on the position information regarding the vehicle, and outputs the derived or updated recommended speed via the in-vehicle communication unit.

A travel assistance method according to an aspect of the present application is a travel assistance method for assisting traveling of a vehicle, the method including: deriving a recommended speed of the vehicle based on intersection information and traffic signal information regarding a first intersection that are input, and on position information regarding the vehicle; updating the recommended speed, if intersection information and traffic signal information regarding a second intersection are input before the vehicle passes through the first intersection, based on the intersection information and the traffic signal information regarding the second intersection, and on the position information regarding the vehicle; and outputting the derived or updated recommended speed.

A computer program according to an aspect of the present application is a computer program for causing a computer to perform processing for: deriving a recommended speed of the vehicle based on intersection information and traffic signal information regarding a first intersection that are input, and on position information regarding the vehicle; updating the recommended speed, if intersection information and traffic signal information regarding a second intersection are input before the vehicle passes through the first intersection, based on the intersection information and the traffic signal information regarding the second intersection, and on the position information regarding the vehicle; and outputting the derived or updated recommended speed.

According to the present application, travel assistance can be performed while giving consideration to information regarding a traffic signal that is installed farther away.

### BRIEF DESCRIPTION OF THE DRAWINGS

FIG. 1 is a schematic diagram showing a schematic configuration of a travel assistance system according to an embodiment;

FIG. 2 is a block diagram illustrating a configuration of a control system of an in-vehicle device;

FIG. 3 is a conceptual diagram illustrating a configuration example of intersection information;

FIG. 4 is a conceptual diagram illustrating a configuration example of traffic signal information;

FIG. 5 is a flowchart illustrating a processing procedure performed by the in-vehicle device according to Embodiment 1;

FIG. 6 is a schematic diagram showing a display example of a recommended vehicle speed range;

FIG. 7 is a schematic diagram showing a display example in a stopped state; and

FIG. 8 is a schematic diagram showing a display example when turning right.

### DETAILED DESCRIPTION OF PREFERRED EMBODIMENTS

Aspects of the present disclosure will be described below. At least some of the following aspects may also be combined in any manner.

A travel assistance device according to an aspect of the present application is a travel assistance device to be mounted in a vehicle, the device including: an in-vehicle communication unit to which position information regarding the vehicle, intersection information, and traffic signal information are input; and a vehicle speed deriving unit configured to derive a recommended speed of the vehicle, the vehicle speed deriving unit being communicably connected to the in-vehicle communication unit, wherein the vehicle speed deriving unit derives the recommended speed of the vehicle based on intersection information and traffic signal information regarding a first intersection that are input from the in-vehicle communication unit, and on the position information regarding the vehicle, updates the recommended speed, if intersection information and traffic signal information regarding a second intersection are input before the vehicle passes through the first intersection, based on the intersection information and the traffic signal information regarding the second intersection, and on the position information regarding the vehicle, and outputs the derived or updated recommended speed via the in-vehicle communication unit.

According to the above aspect, if the intersection information and the traffic signal information regarding the first intersection are input, the recommended speed of the vehicle is derived. If the intersection information and the traffic signal information regarding the second intersection are input before the vehicle passes through the first intersection, the recommended speed is updated in accordance with the input intersection information and traffic signal information. That is to say, it is possible to present, to the driver of the vehicle, a recommended speed that is determined while giving consideration to not only information regarding the traffic signal that is closest to the vehicle but also information regarding a traffic signal that is located farther away.

In the travel assistance device according to an aspect of the present application, the vehicle speed deriving unit updates the recommended speed if the second intersection is located farther away than the first intersection from the vehicle, and intersection information and traffic signal information regarding a third intersection information that is located yet farther away than the second intersection from the vehicle have not been input, and also if the vehicle can pass through both the first intersection and the second intersection without stopping.

According to the above aspect, the recommended speed can be updated in accordance with the traffic signal information regarding the traffic signal that is farthest from the vehicle.

In the travel assistance device according to an aspect of the present application, the recommended speed is set as a vehicle speed range having a lower limit value and an upper limit value, and the vehicle speed deriving unit updates the recommended speed by changing the lower limit value to a value that is greater than or equal to a lowest value of the vehicle, the lowest value being recommended for passing through the second intersection.

According to the above aspect, the lower limit value of the recommended speed is changed such that the vehicle can pass through the traffic signal installed at the intersection that is farthest from the vehicle.

In the travel assistance device according to an aspect of the present application, the vehicle speed deriving unit updates the recommended speed if the second intersection is located farther away than the first intersection from the vehicle, and the vehicle can pass through the first intersection without stopping, and also if the vehicle cannot pass through the second intersection.

According to the above aspect, the recommended speed is updated if the vehicle cannot pass through the second intersection that is located farther away than the first intersection.

In the travel assistance device according to an aspect of the present application, the recommended speed is set as a vehicle speed range having a lower limit value and an upper limit value, and the vehicle speed deriving unit updates the recommended speed by changing the upper limit value to a value that is lower than the upper limit value.

According to the above aspect, if the vehicle can pass through the first intersection but cannot pass through the second intersection that is located farther away than the first intersection, the upper limit value of the recommended speed is changed such that the vehicle does not accelerate unnecessarily.

A travel assistance method according to an aspect of the present application is a travel assistance method for assisting traveling of a vehicle, the method including: deriving a recommended speed of the vehicle based on intersection information and traffic signal information regarding a first intersection that are input, and on position information regarding the vehicle; updating the recommended speed, if intersection information and traffic signal information regarding a second intersection are input before the vehicle passes through the first intersection, based on the intersection information and the traffic signal information regarding the second intersection, and on the position information regarding the vehicle; and outputting the derived or updated recommended speed.

According to the above aspect, if the intersection information and the traffic signal information regarding the first intersection are input, the recommended speed of the vehicle is set. If the intersection information and the traffic signal information regarding the second intersection are input before the vehicle passes through the first intersection, the recommended speed is updated in accordance with the input intersection information and the traffic signal information. That is to say, it is possible to present, to the driver of the vehicle, a recommended speed that is determined while giving consideration to not only information regarding the traffic signal that is closest to the vehicle but also information regarding a traffic signal that is located farther away.

A computer program according to an aspect of the present application is a computer program for causing a computer to perform processing for: deriving a recommended speed of the vehicle based on intersection information and traffic signal information regarding a first intersection that are input, and on position information regarding the vehicle; updating the recommended speed, if intersection information and traffic signal information regarding a second intersection are input before the vehicle passes through the first intersection, based on the intersection information and the traffic signal information regarding the second intersection, and on the position information regarding the vehicle; and outputting the derived or updated recommended speed.

According to the above aspect, if the intersection information and the traffic signal information regarding the first intersection is input, the recommended speed of the vehicle is set. If the intersection information and the traffic signal information regarding the second intersection are input before the vehicle passes through the first intersection, the recommended speed is updated in accordance with the input intersection information and the traffic signal information. That is to say, it is possible to present, to the driver of the vehicle, a recommended speed that is determined while giving consideration to not only information regarding the traffic signal that is closest to the vehicle but also information regarding a traffic signal that is located farther away.

Hereinafter, the present disclosure will be described in detail based on the drawings showing an embodiment thereof.

### Embodiment 1

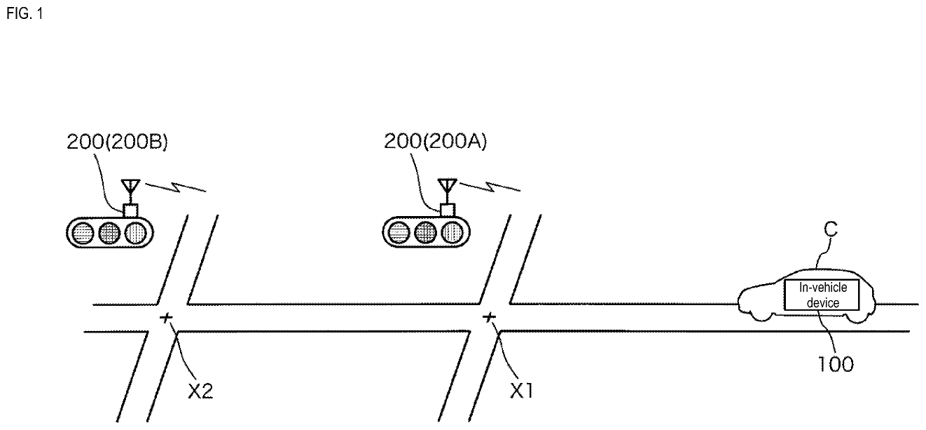

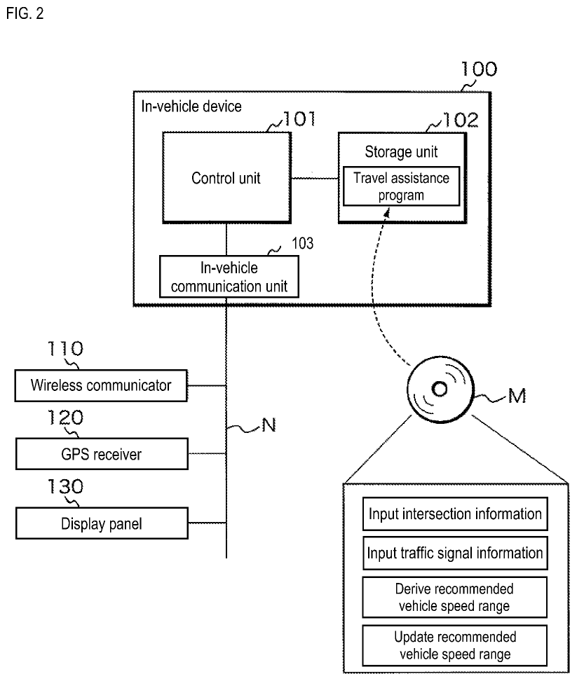

FIG. 1 is a schematic diagram showing a schematic configuration of a travel assistance system according to the present embodiment. The travel assistance system according to this embodiment includes an in-vehicle device 100 (see FIG. 2), which is mounted in a vehicle C, and road-side communicators 200, which are installed on a road. The in-vehicle device 100 receives various kinds of information transmitted from the road-side communicators 200, and outputs information related to travel assistance for the vehicle C based on the received information.

Each of the road-side communicators 200 is installed near an intersection, for example, and regularly and repeatedly transmits intersection information, which includes information regarding the position of the intersection, traffic signal information, which includes information regarding color change in the traffic signal installed at the intersection, and so on. According to a message standard used in the North American DSRC (Dedicated Short Range Communication), MAP (Map Data) corresponds to the intersection information, and SPaT (Signal Phase and Timing) corresponds to the traffic signal information.

Note that not all of the road-side communicators 200 in the system need to transmit both the intersection information and the signal information, and the system may include a road-side communicator 200 that does not transmit the traffic signal information but only transmits the intersection information.

Radio waves that pertain to a 5.9 GHz transmission band, for example, are used in wireless communication between the in-vehicle device 100 and the road-side communicators 200. Wireless communication using radio waves that pertain to such a transmission band has characteristics of weak directivity and a wide communication area compared with infrared communication using light beacons. For this reason, there is a possibility that the in-vehicle device 100 not only receives information transmitted from a road-side communicator 200 (200A) installed near an intersection X1 that is closest to the vehicle C, but also receives information transmitted from a road-side communicator 200 (200B) installed near an intersection X2 that is located farther away.

If the in-vehicle device 100 according to this embodiment receives information transmitted from the road-side communicator 200A installed near the closest intersection X1, and also receives information transmitted from the road-side communicator 200B installed near the intersection X1 that is located farther away, the in-vehicle device 100 performs travel assistance while giving consideration to the information from the road-side communicator 200B.

FIG. 2 is a block diagram illustrating a configuration of a control system of the in-vehicle device 100. The in-vehicle device 100 is an ECU (Electronic Control Unit) for controlling equipment in the vehicle C, for example, and includes a control unit 101, a storage unit 102, an in-vehicle communication unit 103, and so on.

The control unit 101 includes a CPU (Central Processing Unit), a ROM (Read Only Memory), a RAM (Random Access Memory), and so on. The CPU in the control unit 101 controls operations of the aforementioned hardware provided in the in-vehicle device 100 and causes the in-vehicle device 100 to function as a travel assistance device according to the present application by executing a program stored in the ROM or the storage unit 102. The RAM in the control unit 101 temporarily stores various kinds of data that is generated while the program is being executed.

Note that the configuration of the control unit 101 is not limited to the above-described one, and need only be one or more processing circuits that include a single-core CPU, a multi-core CPU, a microcomputer, a volatile or non-volatile memory, or the like. The control unit 101 may also have functions of a clock for outputting date and time information, a timer for measuring an elapsed time since a measurement-start instruction is given until a measurement-end instruction is given, a counter for counting the number, or the like.

The memory 102 includes a non-volatile memory, such as an EEPROM (Electronically Erasable Programmable Read Only Memory). The storage unit 102 stores programs to be executed by the control unit, 101, data required to execute these programs, or the like.

The programs stored in the storage unit 102 may include a travel assistance program for causing the control unit 101 to perform processing to output travel assistance information based on information received from the road-side communicators 200. The control unit 101 realizes a travel assistance method according to this embodiment by executing the travel assistance program.

Note that the programs stored in the storage unit 102 may be provided through a recording medium M that readably stores these programs. The recording medium M is, for example, a portable memory such as a CD-ROM, a USB memory, an SD card, a micro SD card, or a compact flash (registered trademark). The control unit 101 can read various programs from the recording medium M using a reader device (not shown), and install the read various programs in the storage unit 102. Also, the programs to be stored in the storage unit 102 may be provided through communication. For example, a configuration may be employed in which a communication terminal (not shown) capable of communicating with an external server is connected to the in-vehicle communication unit 103, and a program is downloaded from the external server using the communication terminal. In this case, the control unit 101 can fetch the program downloaded using the communication terminal from the in-vehicle communication unit 103, and install the fetched program in the storage unit 102.

The in-vehicle communication unit 103 includes a communication interface for connecting various devices, other ECUs, or the like, via an in-vehicle communication line N. The in-vehicle communication unit 103 communicates with various devices or other ECUs using a communication method conforming to any of various communication standards used in an in-vehicle network, such as a CAN (Controller Area Network), a LIN (Local Interconnect Network), a MOST (Media Oriented Systems Transport), or Ethernet (registered trademark).

In this embodiment, devices connected to the in-vehicle communication unit 103 via the in-vehicle communication line N include a wireless communicator 110, a GPS receiver 120, and a display panel 130.

The wireless communicator 110 includes, for example, a receiving antenna for receiving radio waves in a specific frequency band (e.g. 5.9 GHz band) transmitted from the road-side communicators 200, a receiving module for demodulating the radio waves received by the receiving antenna and outputting a data signal obtained through this demodulation. The wireless communicator 110 transmits the data signal obtained by the receiving module to the in-vehicle device 100 via the in-vehicle communication line N.

Although this embodiment has described a wireless communicator 110 that includes a receiving antenna and a receiving module, the wireless communicator 110 may alternatively include, for example, a transmitting module for modulating a data signal that is to be transmitted, a transmitting antenna for transmitting the data signal that has been modulated by the transmitting module, in the form of radio waves in a specific frequency band. Also, the transmission band used in wireless communication with the road-side communicators 200 is not limited to a 5.9 GHz band, and any appropriate wireless communication method may be used while considering the distance that radio waves can reach, the transmission band, or the like, and different wireless communication methods may be used depending on the situation.

The GPS receiver 120 includes a receiving antenna for receiving a GPS signal, which is transmitted from a GPS satellite (not shown), a computation circuit for measuring the current position of the vehicle C based on the received GPS signal, and so on. The GPS receiver 120 transmits position information regarding the measured current position of the vehicle C to the in-vehicle device 100 via the in-vehicle communication line N.

The display panel 130 includes a liquid-crystal panel, an organic EL panel, or the like. The display panel 130 displays information of which an occupant of the vehicle C is to be notified, based on a signal transmitted from the in-vehicle device 100, for example. Note that the display panel 130 may also include an HMI (Human Machine Interface) for accepting an operation made by the occupant.

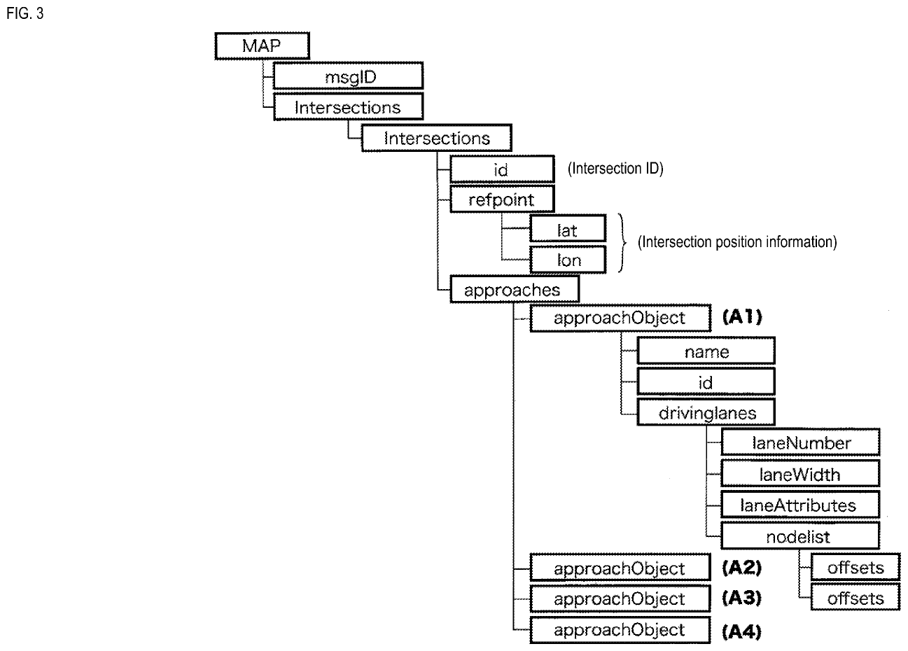

A configuration example of information transmitted by the road-side communicators 200 will be described below. FIG. 3 is a conceptual diagram illustrating a configuration example of intersection information. FIG. 3 shows a configuration example of intersection information (MAP) used in the North American DSRC. The intersection information includes a message ID (msgID), an interchange ID (id), the latitude (lat) and the longitude (lon) that indicate the center coordinates of the intersection, and information regarding approaches (approachObject) to the interchange. The latitude and the longitude that indicate the center coordinates of the intersection correspond to intersection position information. In the example shown in FIG. 3, information regarding four approaches A1 to A4 is included in the intersection information. The approach A1 is an approach to proceed to the intersection from the southern side, for example. In the intersection information, information regarding traffic lanes that constitute the approach A1 (drivinglanes) is described in association with the name (name) and the identifier (id) of the approach A1. Information regarding each traffic lane includes the lane number (laneNumber), the lane width (laneWidth), attributes (laneAttributes), and so on, of the traffic lane. Although the information regarding only one of the traffic lanes constituting the approach A1 is shown due to the spatial limitations of the diagrams, if the approach A1 is constituted by a plurality of traffic lanes, information regarding the respective traffic lanes is described. Although not shown in detail, the same also applies to the other approaches A2 to A4. Note that the intersection information transmitted by the road-side communicators 200 may also be encrypted. If the wireless communicator 110 receives encrypted intersection information, the wireless communicator 110 performs processing to decrypt the received intersection information.

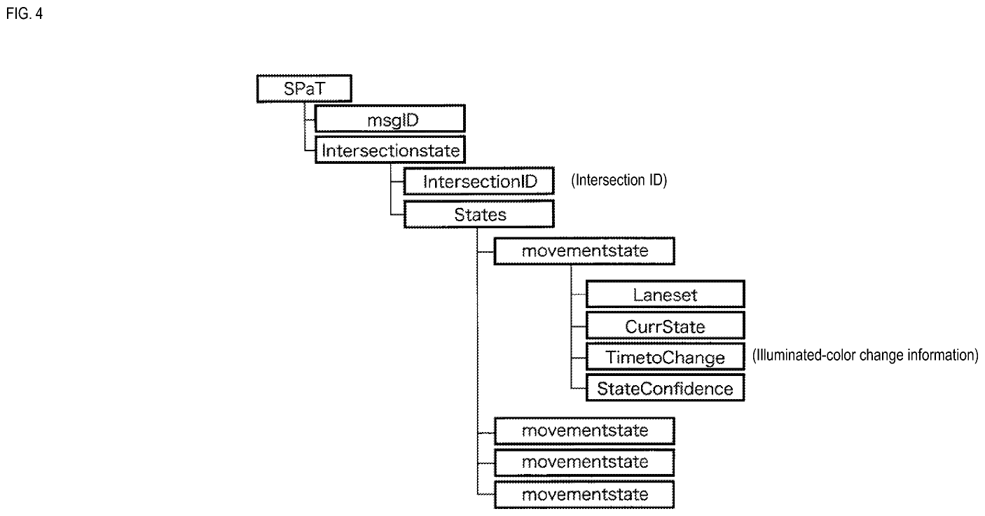

FIG. 4 is a conceptual diagram illustrating a configuration example of traffic signal information. FIG. 4 shows a configuration example of traffic signal information (SPaT) used in the North American DSRC. The traffic signal information includes a message ID (msgID), an intersection ID (IntersectionID), and information indicating the state (movementstate) of a traffic signal installed at the intersection. As the traffic signal information regarding a traffic signal installed at an intersection that is identified by the intersection ID in the intersection information, the same intersection ID as that in the intersection information is used. Information indicating the state of a traffic signal is prepared for each traffic signal, and includes the traffic lane number of a traffic lane in which the traffic signal is installed (Laneset), the color-illumination state of the traffic signal (CurrState), illuminated-color change information that indicates the remaining time until the illuminated color changes from the current color to the next color (TimetoChange), event content reliability (StateConfidence), and so on. Note that the traffic signal information transmitted by the road-side communicators 200 may also be encrypted. If the wireless communicator 110 receives encrypted traffic signal information, the wireless communicator 110 performs processing to decrypt the received traffic signal information.

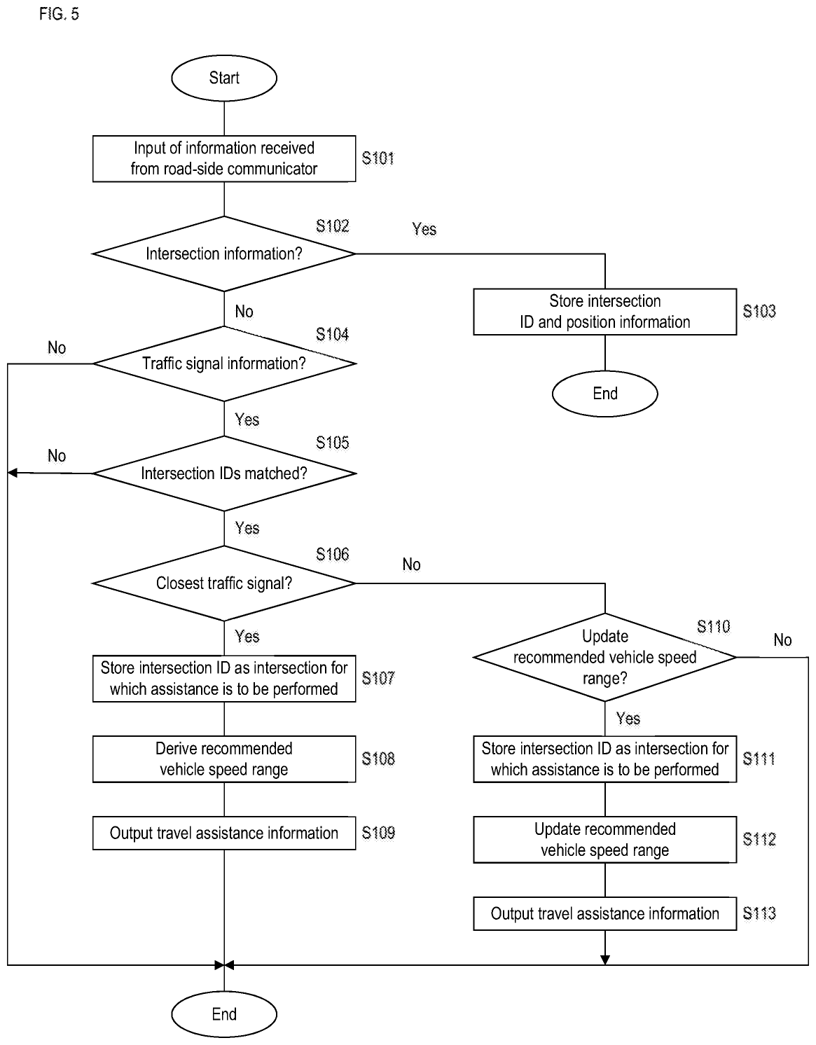

Operations of the in-vehicle device 100 will be described below. FIG. 5 is a flowchart illustrating a processing procedure performed by the in-vehicle device 100 according to Embodiment 1. If the wireless communicator 110 mounted in the vehicle C receives information that is transmitted, as appropriate, from a road-side communicator 200, the wireless communicator 110 transmits the received information to the in-vehicle device 100 via the in-vehicle communication line N. The in-vehicle device 100 receives the information transmitted from the wireless communicator 110, at the in-vehicle communication unit 103. If information from the road-side communicator 200 is input through the in-vehicle communication unit 103 (step S101), the control unit 101 in the in-vehicle device 100 determines whether or not the input information is intersection information (MAP) (step S102).

If it is determined that the input information is the intersection information (S102: YES), the control unit 101 extracts the intersection ID and the intersection position information (latitude and longitude) from the intersection information, and stores the extracted intersection ID and intersection position information in the storage unit 102 (step S103). After storing the intersection ID and the position information in the storage unit 102, the control unit 101 ends the processing of this flowchart.

If it is determined that the input information is not the intersection information (S102: NO), the control unit 101 determines whether or not the input information is traffic signal information (SPaT) (step S104). If it is determined that the input information is not the traffic signal information (S104: NO), the control unit 101 ends the processing of this flowchart.

If it is determined that the input information is the traffic signal information (S104: YES), the control unit 101 determines whether or not the intersection ID included in the input traffic signal information matches an intersection ID in intersection information stored in the storage unit 102 (step S105). If these intersection IDs do not match (S105: NO), that is, if the intersection ID in the input traffic signal information does not match the intersection ID in the intersection information stored in the storage unit 102, or if no intersection ID in intersection information is stored in the storage unit 102, the control unit 101 ends the processing of this flowchart without outputting travel assistance information.

If it is determined that the intersection IDs match (S105: YES), the control unit 101 determines whether or not the traffic signal installed at this intersection is the traffic signal that is closest to the vehicle C (step S106). As will be described later, in this embodiment, the intersection ID of an intersection for which assistance is to be performed is stored in the storage unit 102. The control unit 101 determines whether or not a traffic signal is the one that is closest to the vehicle C by comparing position information regarding the intersection that is identified by the intersection ID stored in the storage unit 102 with the newly-input intersection position information, based on a reference that is the position information regarding the vehicle C from the GPS receiver 102 that is input through the in-vehicle communication unit 103.

If it is determined that the traffic signal is the closest one (S106: YES), the control unit 101 regards the intersection at which this traffic signal is installed as an intersection for which assistance is to be performed, and stores the intersection ID in the storage unit 102 (step S107).

Next, the control unit 101 derives a recommended vehicle speed range of the vehicle C (step S108). The control unit 101 can calculate the distance from the vehicle C to the intersection based on the position information regarding the vehicle C from the GPS receiver 120 and the position information included in the intersection information regarding the target intersection. Also, the control unit 101 can comprehend the time it will take until the traffic signal changes from green to red, for example, based on the illuminated-color change information included in the traffic signal information with the matched intersection ID. The control unit 101 calculates the lowest speed of the vehicle C at which the vehicle C can pass through the intersection before the traffic signal changes from green to red, based on the distance from the vehicle C to the intersection and the time it will take until the traffic signal changes from green to red. The control unit 101 also calculates the highest speed by adding an appropriate range (e.g. 20 km/h) to the calculated lowest speed. If the calculated highest speed exceeds the legal speed limit, the legal speed limit may be used as the upper limit. In step S108, the control unit 101 derives a recommended vehicle speed range with the calculated lowest speed of the vehicle C serving as a lower limit, and the calculated highest speed serving as the upper limit. That is to say, the control unit 101 functions as a vehicle speed deriving unit for deriving a recommended speed of the vehicle C.

Although this embodiment employs a configuration in which the recommended vehicle speed range is derived, a configuration may alternatively be employed in which the lowest speed of the vehicle C at which the vehicle C can pass through the intersection before the traffic signal changes from green to red is derived as a recommended speed, instead of deriving the recommended vehicle speed range.

If the calculated lowest speed falls below the legal speed limit, the control unit 101 may generate a message for suggesting deceleration, without deriving a recommended vehicle speed range. Furthermore, if it can be determined based on the illuminated-color change information included in the traffic signal information that the color of the traffic signal that is illuminated when the vehicle C passes through the intersection is red, the control unit 101 may generate a message for suggesting deceleration, without deriving a recommended vehicle speed range.

Next, the control unit 101 generates travel assistance information that includes the set recommended vehicle speed range or a message for suggesting deceleration, and outputs the generated travel assistance information from the in-vehicle communication unit 103 (step S109). The travel assistance information output from the in-vehicle communication unit 103 is displayed on the display panel 130.

If it is determined in step S106 that the traffic signal is not the closest one (S106: NO), the control unit 101 determines whether or not to update the recommended vehicle speed range (step S110). For example, the control unit 101 determines whether or not traffic signal information regarding the farthest traffic signal has been received, by comparing the position information regarding the intersection that is identified by the intersection ID stored in the storage unit 102 with the newly-received intersection position information, based on a reference that is the position information regarding the vehicle C from the GPS receiver 120. If traffic signal information regarding the traffic signal that is farthest from the vehicle C has been received, and it has been determined based on the illuminated-color change information included in the received traffic signal information that the vehicle can pass through the farthest traffic signal, the control unit 101 determines to update the recommended vehicle speed range.

If it is determined in step 5110 to not update the recommended vehicle speed range (S110: NO), the control unit 101 ends the processing of this flowchart.

If it is determined in step S110 to update the recommended vehicle speed range (S110: YES), the control unit 101 regards the intersection at which this traffic signal is installed as an intersection for which assistance is to be performed, and stores the intersection ID of the intersection in the storage unit 102 (step S111).

Next, the control unit 101 updates the recommended vehicle speed range of the vehicle C (step S112). For example, if traffic signal information regarding the traffic signal that is farthest from the vehicle C is received, the control unit 101 updates the recommended vehicle speed range according to the following procedure. Initially, the control unit 101 calculates the lowest speed of the vehicle C at which the vehicle C can pass through the intersection before the traffic signal that is farthest from the vehicle C changes from green to red, based on the distance from the vehicle C to the intersection and the time it will take until the traffic signal changes from green to red. Next, the control unit 101 updates the recommended vehicle speed range by changing the lower limit value of the recommended vehicle speed range to a value that is greater than or equal to the calculated lowest speed. If a recommended speed has been given instead of the recommended vehicle speed range, the control unit 101 may update the recommended speed by changing the recommended speed to a value that is greater than or equal to the calculated lowest speed.

Note that the above-described flowchart has illustrated a procedure for updating the recommended vehicle speed range by changing the lower limit value of the recommended vehicle speed range in accordance with the traffic signal information regarding the traffic signal that is farthest from the vehicle C, in the case where a plurality of pieces of intersection information and traffic signal information are received, and where the vehicle C can pass through the farthest traffic signal without stopping. However, a configuration may alternatively be employed in which the upper limit value of the recommended vehicle speed range is changed, depending on the received traffic signal information. For example, a configuration may be employed in which, if the vehicle C needs to stop at a traffic signal that is adjacent to the traffic signal that is closest to the vehicle C, the recommended vehicle speed range is updated by changing the upper limit value of the recommended vehicle speed range. In this case, the control unit 101 may update the recommended vehicle speed range by subtracting a preset value (e.g. 10 km/h) from the upper limit value of the set recommended vehicle speed range.

Next, the control unit 101 generates travel assistance information that includes the updated recommended vehicle speed range, and outputs the generated travel assistance information from the in-vehicle communication unit 103 (step S113). The travel assistance information output from the in-vehicle communication unit 103 is displayed on the display panel 130.

Note that, if the lowest speed calculated in step S112 falls below the legal speed limit, the control unit 101 does not need to update the recommended vehicle speed range.

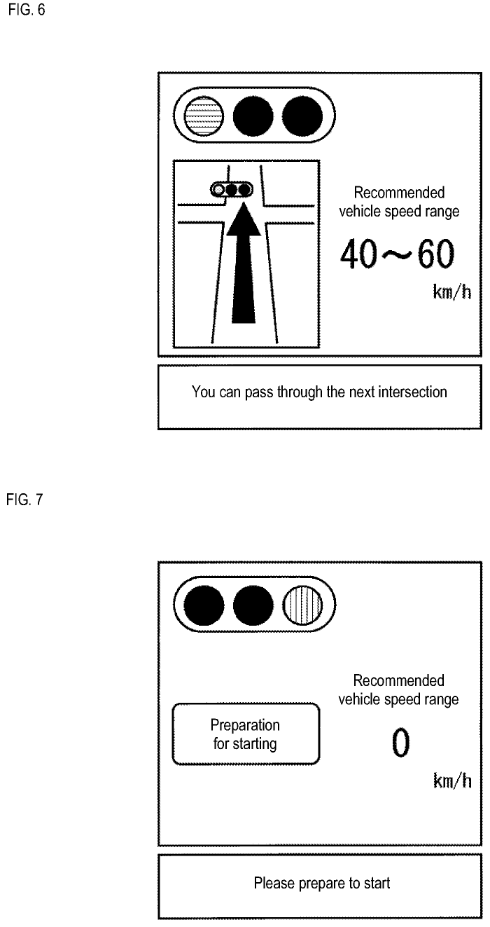

Display examples of the recommended vehicle speed range will be described below. FIG. 6 is a schematic diagram showing a display example of a recommended vehicle speed range. In the display example in FIG. 6, the facts that the illuminated color of a traffic signal that is installed at the next intersection is green, that the recommended vehicle speed range is 40 to 60 km/h, and that the vehicle can pass through the next intersection are indicated with schematic diagrams and messages. Although the display example in FIG. 6 employs a configuration in which the recommended vehicle speed range is displayed, a configuration may alternatively be employed in which the lowest speed of the vehicle C at which the vehicle C can pass through the intersection before the traffic signal changes from green to red is displayed as a recommended speed.

FIG. 7 is a schematic diagram showing a display example in a stopped state. If the received traffic signal information includes the remaining time until the illuminated color of a traffic signal changes from red to green, the control unit 101 may generate travel assistance information for suggesting that the vehicle C should keep stopping or prepare to start, and output the generated travel assistance information through the in-vehicle communication unit 103, thereby displaying, on the display panel 130, information for suggesting that the vehicle C should keep stopping or prepare to start. In the display example in FIG. 7, the facts that the illustrated color of a traffic signal installed at an intersection at which the vehicle C is stopping is red, that the illuminated light of the traffic signal will change from red to green after 20 seconds, and that the vehicle C should prepare to start are indicated with a schematic diagram and messages.

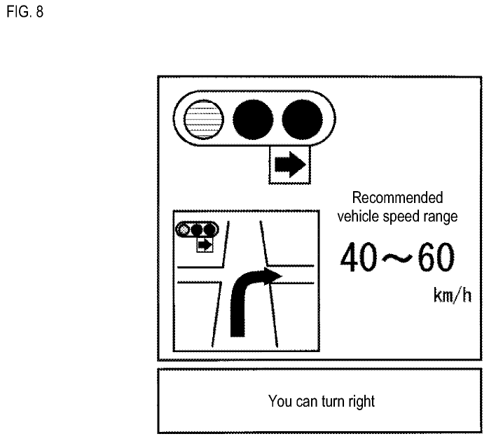

FIG. 8 is a schematic diagram showing a display example when turning right. If the received traffic signal information includes the remaining time until an arrow signal transitions from an on-state to an off-state, and the vehicle C is about to turn right or left in accordance with the arrow signal, the control unit 101 can determine, based on the length of the remaining time, whether or not the vehicle C can turn right or left at the next intersection. If it is determined that the vehicle C can turn right or left at the next intersection, travel assistance information that includes the recommended vehicle speed range of the vehicle C may be generated and output through the in-vehicle communication unit 103, thereby displaying the recommended vehicle speed range on the display panel 130. In the display example in FIG. 8, the facts that the arrow signal in a traffic signal installed at the next intersection is illuminated, that the recommended vehicle speed range is 40 to 60 km/h, and that the vehicle C can turn right at the next intersection are indicated with schematic diagrams and messages.

As described above, according to this embodiment, if the intersection ID included in the intersection information matches the intersection ID included in the traffic signal information, travel assistance for the vehicle C can be performed for a driver thereof by outputting the travel assistance information that is based on the traffic signal information. At this time, it is possible to derive the recommended vehicle speed range for the vehicle speed of the vehicle C, and include the derived recommended vehicle speed range in the travel assistance information. If the intersection information and the traffic signal information regarding a plurality of intersections are received, the recommended vehicle speed range can be updated based on the traffic signal information regarding a traffic signal that is located farther away.

The disclosed embodiment is an example in all aspects, and should be understood as not restrictive. The scope of the present disclosure is indicated not by the above-described meanings but by the claims, and is intended to include all modifications within the meanings and scope equivalent to the claims.

What is claimed is:

1. A travel assistance device to be mounted in a vehicle, the device comprising:
an in-vehicle communication unit to which position information regarding the vehicle, intersection information, and traffic signal information are input; and
a vehicle speed deriving unit configured to derive a recommended speed of the vehicle, the vehicle speed deriving unit being communicably connected to the in-vehicle communication unit,
wherein the vehicle speed deriving unit
derives the recommended speed of the vehicle based on intersection information and traffic signal information regarding a first intersection that are input from the in-vehicle communication unit, and on the position information regarding the vehicle,
updates the recommended speed, if intersection information and traffic signal information regarding a second intersection are input before the vehicle passes through the first intersection, based on the intersection information and the traffic signal information regarding the second intersection, and on the position information regarding the vehicle, and
outputs the derived or updated recommended speed via the in-vehicle communication unit.

2. The travel assistance device according to claim 1,
wherein the vehicle speed deriving unit updates the recommended speed if the second intersection is located farther away than the first intersection from the vehicle, and intersection information and traffic signal information regarding a third intersection information that is located yet farther away than the second intersection from the vehicle have not been input, and also if the vehicle can pass through both the first intersection and the second intersection without stopping.

3. The travel assistance device according to claim 2,
wherein the recommended speed is set as a vehicle speed range having a lower limit value and an upper limit value, and
the vehicle speed deriving unit updates the recommended speed by changing the lower limit value to a value that is greater than or equal to a lowest value of the vehicle, the lowest value being recommended for passing through the second intersection.

4. The travel assistance device according to claim 1,
wherein the vehicle speed deriving unit updates the recommended speed if the second intersection is located farther away than the first intersection from the vehicle, and the vehicle can pass through the first intersection without stopping, and also if the vehicle cannot pass through the second intersection.

5. The travel assistance device according to claim 4,
wherein the recommended speed is set as a vehicle speed range having a lower limit value and an upper limit value, and
the vehicle speed deriving unit updates the recommended speed by changing the upper limit value to a value that is lower than the upper limit value.

6. A travel assistance method for assisting traveling of a vehicle, the method comprising:
deriving a recommended speed of the vehicle based on intersection information and traffic signal information regarding a first intersection that are input, and on position information regarding the vehicle;
updating the recommended speed, if intersection information and traffic signal information regarding a second intersection are input before the vehicle passes through the first intersection, based on the intersection information and the traffic signal information regarding the second intersection, and on the position information regarding the vehicle; and
outputting the derived or updated recommended speed.

7. A computer program for causing a computer to perform processing for:
deriving a recommended speed of the vehicle based on intersection information and traffic signal information regarding a first intersection that are input, and on position information regarding the vehicle;
updating the recommended speed, if intersection information and traffic signal information regarding a second intersection are input before the vehicle passes through the first intersection, based on the intersection information and the traffic signal information regarding the second intersection, and on the position information regarding the vehicle; and
outputting the derived or updated recommended speed.
